(19) United States
(12) Patent Application Publication
(10) Pub. No.: US 2022/0171832 A1
(43) Pub. Date: Jun. 2, 2022

(54) SCALABLE KEY MANAGEMENT FOR ENCRYPTING DIGITAL RIGHTS MANAGEMENT AUTHORIZATION TOKENS

(71) Applicant: ARRIS Enterprises LLC, Suwanee, GA (US)

(72) Inventor: Karl M. Gallagher, Londonderry (GB)

(73) Assignee: ARRIS Enterprises LLC, Suwanee, GA (US)

(21) Appl. No.: 17/484,722

(22) Filed: Sep. 24, 2021

Related U.S. Application Data
(60) Provisional application No. 63/119,393, filed on Nov. 30, 2020.

(51) Int. Cl. G06F 21/10; H04L 9/32; H04L 9/08

(52) U.S. Cl. CPC G06F 21/105; H04L 9/3247; H04L 2209/603; H04L 9/0869; H04L 9/3242; H04L 9/0866

(57) ABSTRACT

A method and apparatus for providing a license to a client device, the license providing a key for decrypting a content instance. In one embodiment, the method comprises accepting a token request, the token request having client device credentials including a client device identifier (client ID) and a content instance identifier (content ID), deriving a private key according to a token key seed, a token key identifier (token key ID), and the content ID, generating a token having a payload and a token identifier (token ID) and being digitally signed according to the derived private key; transmitting the generated token to the client; and providing the license to the client device according to the generated token.

### CROSS REFERENCE TO RELATED APPLICATIONS

This claims the benefit of U.S. Provisional Patent Application No. 63/119,393 filed Nov. 30, 2020.

### BACKGROUND

### 1. Field

The present disclosure relates to systems and methods for securely providing content to client devices and in particular that allows for scaleably renewable private cryptographic keys used to secure authorization tokens for web based DRM license services.

### 2. Description of the Related Art

Digital Rights Management (DRM) systems are known in the art. DRM systems control access to proprietary content using a variety of technologies. Typically, the content is encrypted using one or more encryption keys, and decrypted using one or more corresponding decryption keys by the device that provides the content for consumption or transmission elsewhere. Private data communicated between the client device and the headend is typically used to request and receive specific content encryption keys for protected media being consumed by the client.

One of the critical functions of a Digital Rights Management (DRM) system is to provide a root of trust on the client side device(s) on which it is installed. This then underpins the process of device authentication by means of deriving public/private keys for the issuance of digital signatures and application of cryptographic routines on private data that the DRM system wishes to send to remote server hosts. By applying the reverse cryptographic approach the server can both uniquely identify a specific device platform and also verify that an authentic DRM client is currently running. The private data passed by a DRM system is usually within the context of requesting specific content encryption keys for protected media being consumed by the client.

However, a typical DRM solution will also require a means of identifying and authorizing a particular user or subscriber, as a means of providing higher level entitlement access control and other business critical features. This is normally a solution that requires third party augmentation on top of any existing DRM scheme.

One of the methods that can be used to provide user authorization services is to bind a custom third party token to DRM private data for each request. For instance, in a solution for OTT content delivery (via the open internet), the HTTP standard allows for encoding access token data in custom headers or URI string query parameters.

The token may be requested from a remote resource as part of the normal playback workflows implemented within a client side application. An authentication protocol (for example, OAUTH) is used to control the initial dissemination of tokens with a token instance only representing an ephemeral authorization for a specific service—the tokens are not bound to the client device in any way, nor do they provide means for reauthentication of the end-user/subscriber. One such system is disclosed in

In such a system a new token is typically acquired for every streaming session initiated by the client and the authorization is validated by the DRM entitlement server for each license request.

Typically the issued token is protected in a similar way to DRM private data—encryption and digital signatures—providing a means for validating at the receiving end-point.

The cryptographic secrets (such as private keys), need to be shared or negotiated between all system components that need to process said tokens—e.g. the private key for a specific token needs to be available at the issuer and the validation ends.

Private encryption keys associated with the cryptographic obfuscation and verification of authorization tokens should, in general, be renewable, however renewability can introduce the complexities into the system.

### SUMMARY

To address the requirements described above, this document discloses a system and method for providing a license to a client device, the license providing a key for decrypting a content instance. In one embodiment, the method comprises accepting a token request, the token request having client device credentials including a client device identifier (client ID) and a content instance identifier (content ID), deriving a private key according to a token key seed, a token key identifier (token key ID), and the content ID, generating a token having a payload and a token identifier (token ID) and being digitally signed according to the derived private key; transmitting the generated token to the client; and providing the license to the client device according to the generated token. Another embodiment is evidenced by a processor having a communicatively coupled memory having processor instructions for performing the foregoing operations.

### BRIEF DESCRIPTION OF THE DRAWINGS

Referring now to the drawings in which like reference numbers represent corresponding parts throughout:

FIG. 1 is a diagram of an exemplary content distribution network;

FIGS. 2A-2B are diagrams depicting the provision of a license;

FIG. 3 is a diagram illustrating one embodiment of how the access token can be generated;

FIG. 4 is a diagram depicting exemplary tokens;

FIG. 5 is a diagram depicting an exemplary technique for encrypting the token;

FIG. 6 is a diagram depicting exemplary operations used to authenticate and validate the token;

FIG. 7 illustrates an exemplary computer system that could be used to implement processing elements of the content distribution network.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### Overview

One of the methods that can be used to provide user authorization services is to bind a custom access token from a third party to DRM private data for each request. For instance, in a solution for over the top (OTT) content delivery (e.g. via the open Internet), the hypertext transfer protocol (HTTP) standard allows for encoding access token data in custom headers or uniform resource identifier (URI) string query parameters. The access token may be requested from a remote resource as part of the normal playback workflows implemented within an application executing on the client device.

An authentication protocol is used to control the initial dissemination of access tokens with an access token instance only representing an ephemeral (e.g. temporary) authorization for a specific service. The access tokens are not bound to the client device in any way, nor do they provide means for reauthenticating the end-user/subscriber. An exemplary authentication protocol is OAUTH, which is an open standard for access delegation, allowing Internet entities to access their information on other websites, without providing other more primitive authenticating information such as passwords.

In such a system, a new access token is typically acquired for every streaming session initiated by the client device, and the access token is validated by the DRM entitlement server for each license request, before fulfilling the request.

Typically the issued access token is protected using means analogous to those used to protect DRM private data—encryption of data to prevent access and digital signatures for providing a means for validating at the receiving client device to assure the client device is the client device it purports to be.

Access tokens may be a categorized at a high level as being One-Time-Only (OTO), in which case the individual token instance may only be used once, or time-bound, were a token may be reused multiple times within a defined validity period. OTO access tokens provide greater resilience to potential sharing and replay attacks at the expense of requiring a higher churn rate of access token generation, since each client device must always retrieve a new access token for each key request the client device must request.

Time-limited (TL) access tokens can be used to encode information that authorizes a client device to access a specific protected content instance (or set of content instances). This access is typically unrestricted within the time span encoded into the token, and after such time span has expired, access rights are revoked or no longer usable to access content.

As described above, private encryption keys associated with the cryptographic obfuscation and verification of authorization tokens should be renewable, however renewability can introduce the complexities to the system. This arises because the cryptographic secrets used to generate such tokens need to be shared or negotiated between all system components that need to process the tokens—for example, the private key for a specific token needs to be available to both the issuer of the token and the entity that validates the token. Such complexities include: (1) Data consistency considerations related to the sharing or dissemination of the renewed cryptographic keys required to generate and validate the token, (2) The possibility of an unwarranted “in flight” token revocation around a token renewal cycle event (e.g. a token is in the process of being renewed), and (3) Strategies for sharing an updating private keys may influence deployment considerations such as whether a distributed data store is required.

One possible solution is to use a centralized secure data store (Database or Key-Value Storage) to share private keys between systems. This method introduces general complexity related to data storage—security, consistency, fault-tolerance and availability. Another possible solution is to use a pre-agreed set of private keys configured across all systems. This technique introduces maintenance and usability concerns, and also decreases the speed at which key (and hence, token) renewal can be achieved. Described below is the use of a key derivation method that allows new private keys to be generated at arbitrary frequencies without requiring new keys to be shared or configured across all nodes in a given system.

### Content Distribution System

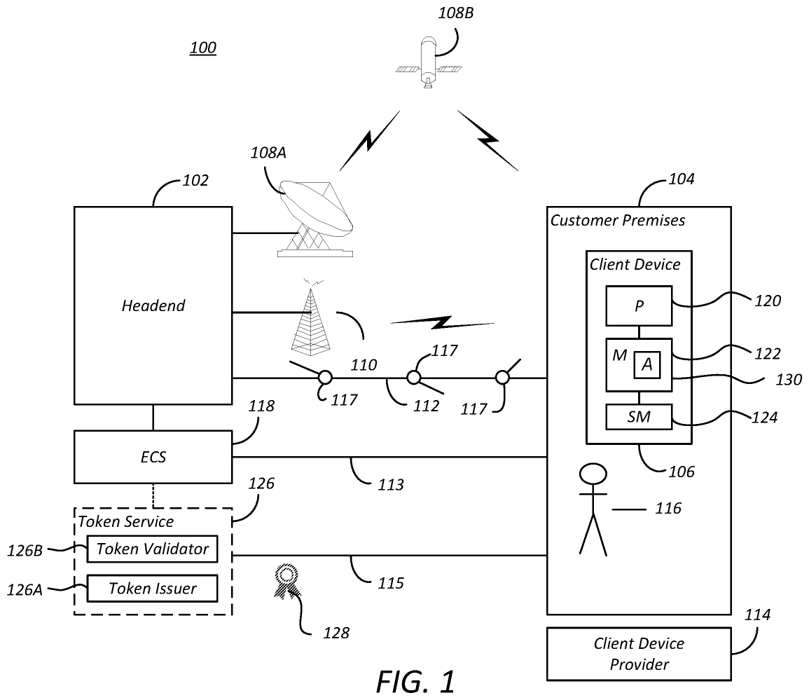

FIG. 1 is a diagram of an exemplary content distribution network (CDN) 100. The CDN 100 comprises content source or headend 102. The headend 102 may be a multi system operator (MSO) that transmits content to a client devices 106 in possession of end users 116 (subscribers) or a content provider that generates content and transmits the content to client devices 106 in possession of MSOs (for eventual transmission to end users). Exemplary client devices 106 include set top boxes (STBs), cable modems, and integrated receiver/decoders (IRDs), but may also be embodied in smart phones, tablet computers, desktop computers, laptop computers, or any device capable of receiving, storing, retransmitting, or presenting content. Client devices 106 are alternatively referred to as customer provided equipment (CPEs) in the following disclosure.

The client device 106 includes the processor 120 communicatively coupled to a typically volatile and random access memory 122 and a non-volatile memory 124, which may be a secure memory. Typically, the client device 106 is installed in the customer premises 104 such as a home or MSO facility, but the client device 106 may be installed in motor vehicle or be carried on the user's person.

In many instances, the client devices 106 provided to the users 116 are manufactured (at least in part) by a client device provider 114. In some embodiments, the client device provider 114 manufactures client devices 106 of one hardware design that can be used with different headends 102, each having different functional requirements. Typically, this is accomplished through modification of the software and/or firmware of the client device 106. The client device provider 114 may also manufacture client devices 106 with different hardware functionality for different headends 102.

Typically, the content and private data transmitted between the headend 102 and the client devices 106 is encrypted or otherwise obfuscate it to protect it from being received by unauthorized entities. Consequently, CDNs 100 typically include a conditional access system (CAS) in which content is encrypted by the headend 102 before transmission to client devices 106, and the client devices 106 decrypt the data transmitted by the headend 102. Client devices 106 may also have the capability to encrypt data transmitted from the client device 106 to the headend 102.

The headend 102 may transmit data via a wired network 112 that includes a plurality of communication nodes 117 interconnected by optical cable or conductive wire. The headend 102 may also transmit data via a wireless connection such as via a terrestrial transmitter 110 or a satellite broadcast system in which data is transmitted via a ground station 108A and a satellite 108B.

In some cases, the CDN 100 also permits the users' client device 106 to transmit information to the headend 102 or an entitlement control service (ECS) 118 such as a license entity or service implemented by a license server. Accordingly, the CDN 100 permits information to be transceived (e.g. transmitted and received) by the headend 102 and ECS 118, and the client device 106. Further, such communication between systems may be asymmetric, with data being transmitted from the headend 102 to the client device 106 via one transmission method, and data being transmitted from the client device 106 to the headend 102 or ECS 118 by another transmission method. For example, it is known for headends 102 to transmit content to subscribers 116 having a client device 106 via satellite 108, but data to be transmitted from the client device 106 to the headend 102, ECS 118 or token service 126 to be transmitted via a communication links such as 112, 113 or 115. The token service 126 may include, for example, a token issuer 126A that generates and issues access token(s) 128 and a token validator 126B, that receives, authenticates, and validates access tokens 128 as described further herein.

For example, the client device 106 may require updated encryption keys (required to decrypt content) when requesting such content or on an occasional basis. In such instances, the client device 106 establishes a secure communication channel with the entitlement control service (ECS) 118 via communication link 113 to obtain a license 252 having such encryption keys, or a means of generating such encryption keys. As a part of this secure communications channel, the client device 106 and the ECS 118 authenticate one another, to verify that each entity is what they claim to be. This is typically accomplished by the exchange of digital certificates signed by a certificate authority (CA) or in intermediate entity. Accordingly, the client device 106 is typically provisioned with a digital certificate for this purpose. For security purposes, such digital certificates expire after passage of time, and a new certificate must be generated and issued. Further, in some embodiments, when the client device 106 desires transmission of encrypted content from the headend 102, the client device 106 first obtains an access token 128 from a token service 126, and present the access token 128 along with the request for a license 252, which is presented to the ECS 116.

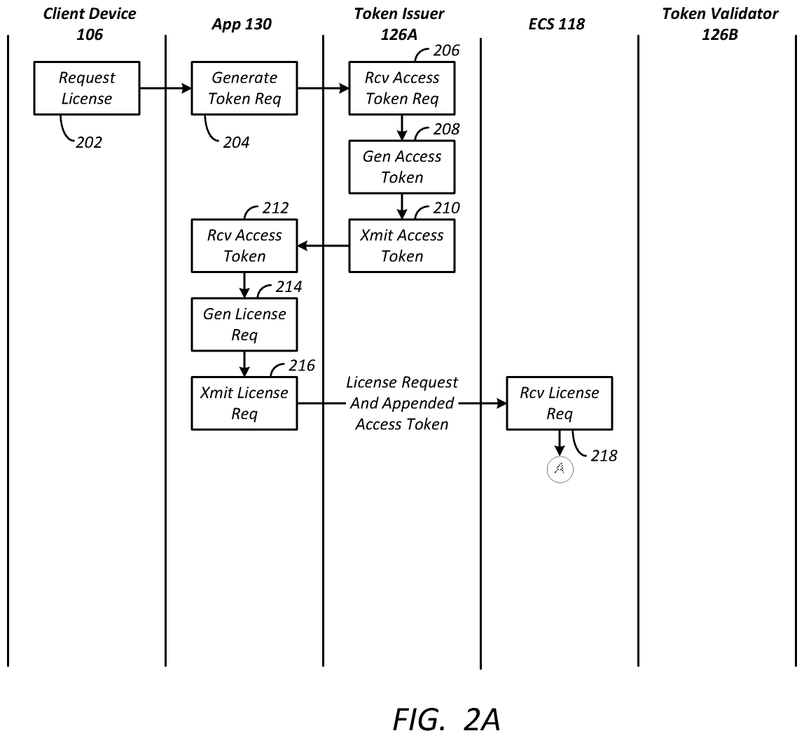

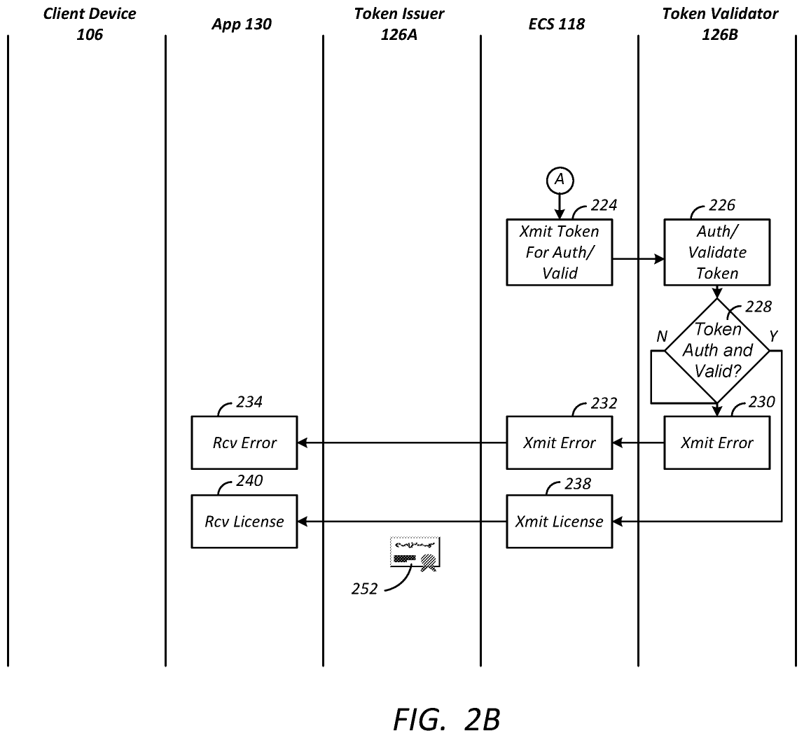

FIGS. 2A-2B are diagrams depicting the provision of a license 252. In block 202, the client device 106 generates a request for a license 252 to receive and decrypt content provides the license request to a DRM application 130 executing on the client device 106. The license request comprises a set of data from the DRM application 130 including the client device credentials, which includes a unique device identifier (device ID), an identifier of the requested content (content ID). In block 204, the DRM application 130 generates a request for an access token 128, and transmits that access token 128 request to a token issuer 126A of the token service 126. The access token request comprises the client device 106 credentials, including the device ID, the content ID, and optionally, a desired time for which the access token 128 will be valid.

In block 206, the access token request is received, and in block 208, the access token 128 is generated. The access token 128 includes an access token ID. The access token ID may be presented in a header of the access token, or may be the data payload. In one embodiment, the token ID is provided in a plaintext (e.g. non-encrypted) portion of the access token 128, but the signature of the both the token header and the token payload is made and provided as a part of the token, to assure the token ID is not tampered with.

In one embodiment, the token is JavaScript Object Notation (JSON) token defined by RFC 7519, which is incorporated by reference herein. JSON web token (JWT) is an open standard that defines a compact and self-contained way to securely transmit information between parties as a JSON object.

The JWT may be incorporated as the payload of a JSON Web Signature object (JWS) [RFC 7515], in which case the information it contains can be digitally signed, typically using a secret (for example, using the HMAC algorithm) or a public/private key pair using RSA or ECDSA.

JWTs can alternatively be both encrypted and digitally signed if incorporated as the plaintext of a JSON Web Encryption object (JWE), as described in RFC 7516, which is hereby incorporated by reference. JWEs allow for use of AES AEAD (Authenticated Encryption with Associated Data) modes to enable simultaneous encryption and digital signature computation from a private symmetric key (for example using AES-GCM [Galois Counter Mode]

The integrity of the data within a signed JWTs can be verified, while encrypted JWTs hide the data from other parties. When tokens are signed using public/private key pairs (or symmetric private keys with AES AEAD), the signature verifies that only the parting holding the private key is the entity that signed the JWT. JWTs are useful in authorization and information exchange contexts. With respect to authorization, each request from an entity to access services or resources includes a JWT specifying the service or resources the client is permitted to access. With respect to information exchange, the JWT provide a means for securely transmitting information between parties. Since JWTs can be signed, the entity receiving a request with the token can be assured that the entity making the request is properly identified, and that the contents have not been tampered with.

In compact form, a JWT includes a number portions separated by a dot (⋅). They include a header, a payload, and a signature and in the case of encrypted JWT an encrypted key and initialization vector. For example, the compact form of a signed JWT can be expressed as “xxxxx.yyyyy.zzzzz”, where “xxxxx” represents the header, “ ” represents the payload, and “zzzzz” represents the signature. Alternatively, the compact form of an encrypted JWT can be expressed as “xxxx.kkkk.iiii.yyyy.zzzz,” where in addition, “kkkk” represents and encrypted AES key and “iiii” represents the AES initialization vector.

The header typically includes the type of token and an indication of the signing and encryption algorithms in use. The payload includes the claims, which are statements about the entity in possession of the token (client device ID) the token itself (access token ID), and additional data. There are three types of claims: registered claims, public claims, and private claims. Registered claims are selected from predefined claims which are not mandatory, but recommended. They include information such as the issuer, the expiration time of the token, the subject, and the audience. Public claims can be defined at will by users, but are usually selected to be consistent with a JWT registry to avoid collisions. Private claims are custom claims created to share information between parties that agree on using them and the protocol and formats for doing so. The third portion of the JWT is the signature. The header (potentially encrypted) and the payload (also potentially encrypted) is combined and signed according to a secret (or private key) using the algorithm specified in the header. The same secret can be used by the recipient to authenticate the token.

As described above, there is a need to have the token be independently generatable by different entities (in this case, the token issuer 126A and the token validator 126B). This can be accomplished by having the entity generating the token 128 (e.g. the token issuer 126A and the entity validating the token (the token validator 126B) be capable of generating the token independently from parameters that include the token ID and the content ID.

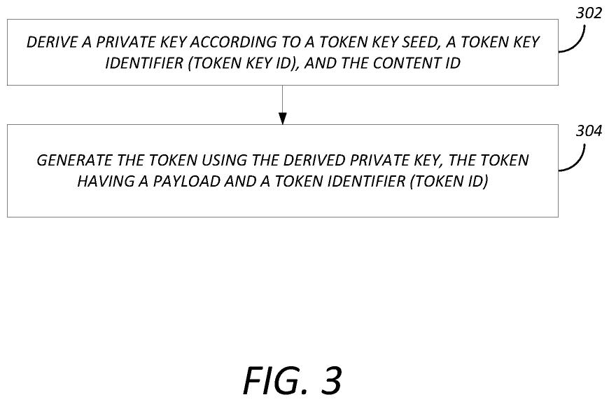

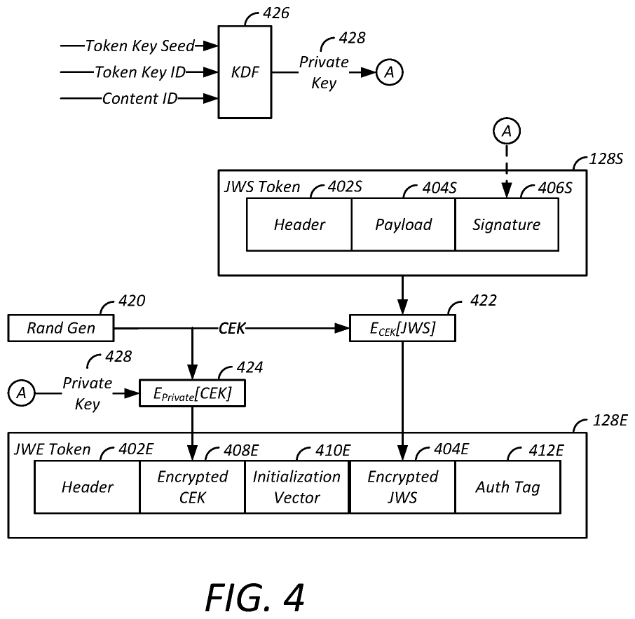

FIG. 3 is a diagram illustrating one embodiment of how the access token 128 can be generated. FIG. 3 is discussed in connection with FIG. 4, which presents a diagram depicting one embodiment of the token 128. In block 302, a private key 428 is derived according to a token key seed, a token key identifier (e.g. token key ID) and the content ID.

In one embodiment, this is accomplished via a software or hardware module 426 implementing a key derivation function (KDF) known to both the issuer and validator of the token. KDFs allow an arbitrary amount of cryptographically secure keys to be generated from a single shared “seed” such as a secret. This private key 428 is used to encrypt the AES key used to encrypt the content of the token. For example, referring to FIG. 4, the JWS token 128S is encrypted by first encryption module 422 according to a claims encryption key (CEK) that is generated, for example, by a random number generator 420, and the CEK used to encrypt the JWS token 128S is itself encrypted according to the private key generated by the KDF module 426 and provided as the encrypted CEK 408E of the JWE 126E. This is further discussed in RFC7519, which is hereby incorporated by reference herein. The encryption cipher used by first encryption module 422 to encrypt the JWS 128S is typically specified in the header 402S of the JWS token 128S via the ‘enc’ attribute, and the encryption cipher that the second encryption module 424 uses to encrypt the CEK is specified in header 402E, is specified by the “alg” attribute. In this disclosure, a symmetric cipher such as AES is employed to allow simpler management without the public key infrastructure and dissemination required for RSA.

When an AES authenticated encryption with associated data (AEAD) symmetric cipher is specified via the ‘enc’ attribute the, JWT ‘claims’ plaintext may be encrypted directly without embedding a JWS object in the token entity. In this case an authenticated encryption cipher such as AES-GCM (Galois/Counter Mode) can be used to encipher the plaintext and generate an authentication signature in a single-pass operation, based on the generated private key. The claims presented in subsequent sections may be generally apply to both methods of operation. Key wrapping and related features are also discussed in RFC7518, which is also incorporated by reference herein.

One suitable KDF is the hash message authentication code (HMAC)-based Extract-and-Expand key derivation function (HKDF) as specified in RFC 5869 and in NIST SP-800 56C, which are hereby incorporated by reference. The hash function for the HKDF can be any hashing function provided by the secure hash algorithm (SHA) family (for example, SHA1, SHA-256, or SHA-512). SHA-1 produces a 128 bit output and is therefore suitable for encrypting almost any AES cipher, but the key length could be extended by using other HKDFs, for example, one implementing SHA-256.

Implementations of HKDF can require a number of input parameters of which three are required to be user-configurable and thus pertinent for use in generating the a unique token key that is used to decrypt the token itself as described in RFC 7516, which is hereby incorporated by reference. These input parameters include:

A key secret: This is a secret key seed value. This secret key seed value must be cryptographically strong and derived from a high entropy source.

A salt: This is random value which is used to strengthen the security of the function and provide independence from the source secret (if unique to each invocation). The salt normally matches the key length of the configured hash function. The salt input parameter need not be kept secret.

Info/context: This is a context input parameter that allows for a unique output of the KDF for different contexts, even reusing the key secret. Like the salt, the info/context data parameter need not be secret.

These input parameters may be mapped to the parameters of a JWT as follows:

The key secret input parameter is mapped to a “Token Key Seed,” which is an internally derived fixed secret provisioned for each deployment, and shared by entities generating the token and decrypting and or authenticating the token 128. Typically, the token key seed is shared between these entities out of band.

The salt input parameter is mapped to the “Token Key ID.” For example, a randomly generated 128 bit identifier of a JWT.

The info/context is mapped to the resource for which access is being requested. For a JWT intended to authorize a specific media item, asset, or content instance, this may be the media ID, asset ID, or content ID.

Referring again to FIG. 3, once the private key is derived, a token 128 is generated, as shown in block 304.

In one embodiment the token128 is a signed token (but unencrypted) such as a JWS token128S. In another embodiment, the token is an encrypted token such a JWE token128E that includes an encrypted version of the JWS token 128S.

JWS Token: The JWS token 128S includes a header 402S, a payload 404S, and a signature 406S. In the illustrated embodiment, the header 402S, the payload 404S and the signature 406 are concatenated. The JWS token 128S is generated by using the private key 428 to sign the payload 404S or both the payload 404S and header 402S of the token 128S, and appending the signature 406S to the header 402S and the payload 404S

As described above, the access token ID may be presented in a header 402S of the access token, or may be the data payload 404S. In one embodiment, the token ID is provided in a plaintext (e.g. non-encrypted) portion of the access token 128, but the signature 406S of the both the token header 402S and the token payload 404S is made and provided as a part of the token128S, to assure the token ID is not tampered with.

JWE Token: The encrypted token 128E comprises an encrypted token header 402E, an encrypted version of the a random key 408E which is generated, for example, by random number generator 420, an initialization vector 410E, the payload 404E (which comprises an encrypted version of the JWS token128S), and an authorization tag 412E.

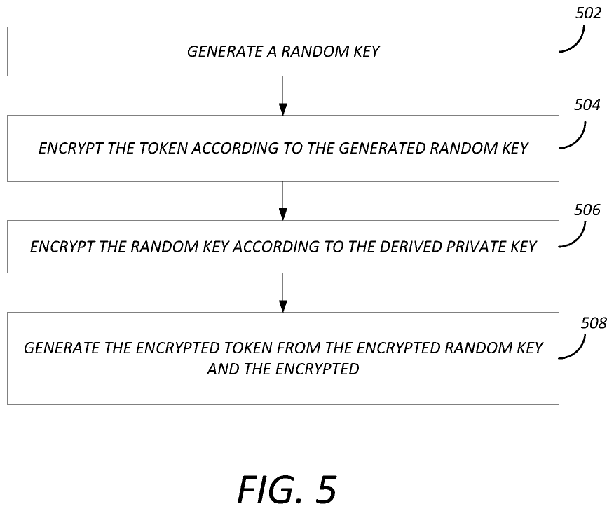

FIG. 5 is a diagram illustrating exemplary operations used to encrypt the generated signed token 128S to generate the encrypted token 128E. In block 502, a random number generator 420 (e.g. at the token issuer 126A) generates a random key such as the CEK. In block 504, encryption operation 422 encrypts the JWS 128S according to the random key to generate encrypted payload 404E. In block 506, the encryption operation 424 encrypts the random key according to the derived private key to generate the encrypted random key 408E. The encrypted random key 408E and the encrypted payload 404E are then used to generate the encrypted token128E, as shown in block 508. As shown in FIG. 4, the encrypted token128E may include a header 502E, the encrypted random key 408E, an initialization vector 410E, the payload 404E, and an authorization tag 412E.

Returning to FIG. 2A, the generated access token 128 is transmitted to the DRM application 130, of the client device 106 as shown in block 210. The DRM application 130 receives the access token 128, and generates a license request, as shown in blocks 212 and 214. The license request includes key request data, which includes the access token 128, and metadata such as the identifier of the requested content (content ID), the token key ID, the client device ID, and cryptographic data required to authenticate and/or protect the privacy of the license request. In one embodiment, the access token 128 is appended to the license request rather than included with the license request, as that solution does not require changes into popular current application program interfaces. In block 216, the DRM application 130 transmits the generated license request to the ECS 118.

In block 218, the ECS 118 receives the license request and access token 128. The access token 128 and metadata is then transmitted to the token authenticator/validator 126B, as shown in block 224. The token authenticator/validator 126B receives the metadata and access token 128, and authenticates and validates the token, as shown in block 226.

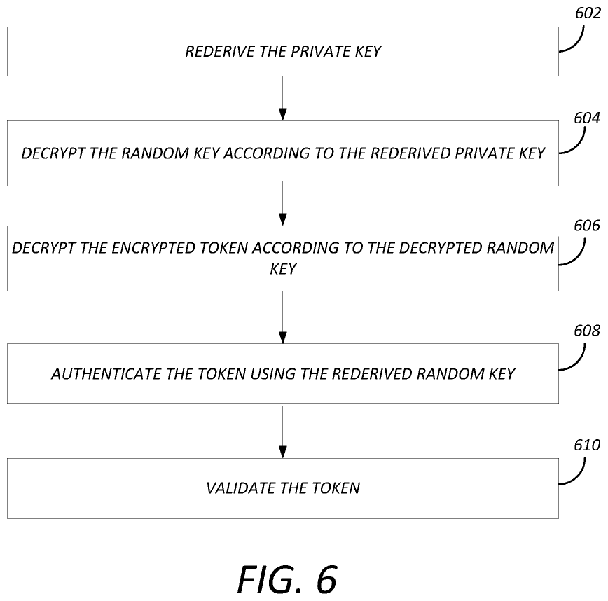

FIG. 6 is a diagram depicting exemplary operations used to authenticate and validate the token 128. First, as shown in block 602, the private key is rederived. This is accomplished by performing operations analogous to those described above, namely, using the same KDF employed by the token issuer 126A to rederive the private key from the token key seed (which is shared between with the token issuer 126A and the token validator 126B) the token key ID (provided as metadata in or along with the license request), and the content ID (also provided in or along with the license request).

If the token is a signed token such as the JWS 128S, the token is authenticated as shown in block 608 and further described below. If the token 128 is an encrypted token 128E, it must first be decrypted. This is accomplished by decrypting the encrypted random key (CEK) according to the rederived private key, as shown in block 604. The encrypted token 128E is then decrypted using the decrypted random key, as shown in block 606. The resulting (unencrypted) token 126S can then be authenticated using the signature 406S, as shown in block 608. This is accomplished by using the private key to sign the appropriate portions of the token 126S using the algorithm described in the header 402S and comparing the resulting signature with the signature 406S included with the token 126S.

The token 128 is then validated using the content ID, and token ID as shown in block 610. Returning to FIG. 2B, if access token 128 is authenticated and valid, the token authenticator/validator 126B transmits a message to the ECS 118 indicating that the token is authenticated and valid. The ECS 118 may then generate a license 252 to consume the content identified by the content ID (which includes the keys or other cryptographic information required to retrieve and decrypt the content), and provide that license 252 to the DRM application 130 according to the generated token as shown in blocks 238 and 240.

If block 228 determines that the access token 128 is not authenticated or not valid, processing is passed to blocks 230, 232 and 234, in which an error is transmitted from the token validator 126B to the ECS 118 and thence to the DRM application 130. In this case, since no license 252 with a decryption key is provided, the client device 106 will not receive and cannot decrypt the content.

In the foregoing embodiment, the entitlement(s) to receive and decrypt the content is determined by the ECS 118 and the ECS generates the license 252 itself. Other embodiments in which the token validator 126B determines such entitlement(s) and generates the license 252, or in which entitlement(s) are determined by one entity and the license 252 generated by the other of these two entities are also envisioned. In still other embodiments, the functions of the token validator 126B are performed within the ECS 118 or licensing service.

### Hardware Environment

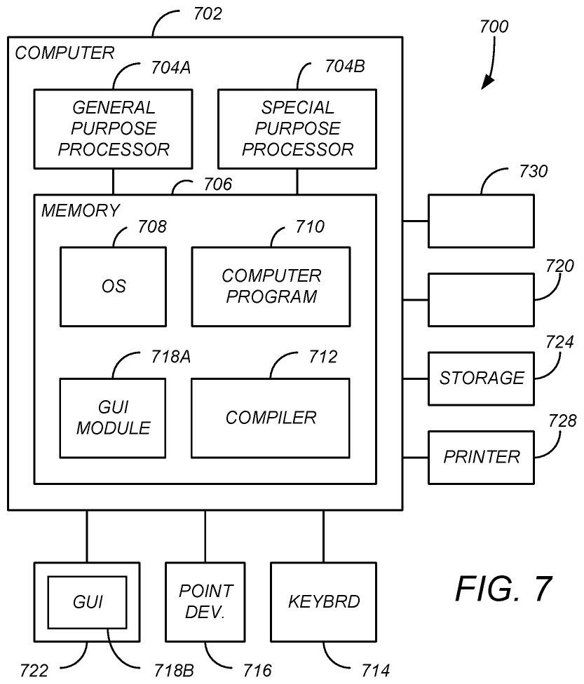

FIG. 7 illustrates an exemplary computer system 700 that could be used to implement processing elements of the above disclosure, including the headend 102, ECS 118, the token service 126, or client device 106. The computer 702 comprises a processor 704 and a memory, such as random access memory (RAM) 706. The computer 702 is operatively coupled to a display 722, which presents images such as windows to the user on a graphical user interface 718B. The computer 702 may be coupled to other devices, such as a keyboard 714, a mouse device 716, a printer 728, etc. Of course, those skilled in the art will recognize that any combination of the above components, or any number of different components, peripherals, and other devices, may be used with the computer 702.

Generally, the computer 702 operates under control of an operating system 708 stored in the memory 706, and interfaces with the user to accept inputs and commands and to present results through a graphical user interface (GUI) module 718A. Although the GUI module 718B is depicted as a separate module, the instructions performing the GUI functions can be resident or distributed in the operating system 708, the computer program 710, or implemented with special purpose memory and processors. The computer 702 also implements a compiler 712 which allows an application program 710 written in a programming language such as COBOL, C++, FORTRAN, or other language to be translated into processor 704 readable code. After completion, the application 710 accesses and manipulates data stored in the memory 706 of the computer 702 using the relationships and logic that was generated using the compiler 712. The computer 702 also optionally comprises an external communication device such as a modem, satellite link, Ethernet card, or other device for communicating with other computers.

In one embodiment, instructions implementing the operating system 708, the computer program 710, and the compiler 712 are tangibly embodied in a computer-readable medium, e.g., data storage device 720, which could include one or more fixed or removable data storage devices, such as a zip drive, floppy disc drive 724, hard drive, CD-ROM drive, tape drive, etc. Further, the operating system 708 and the computer program 710 are comprised of instructions which, when read and executed by the computer 702, causes the computer 702 to perform the operations herein described. Computer program 710 and/or operating instructions may also be tangibly embodied in memory 706 and/or data communications devices 730, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

The foregoing discloses an apparatus and method for providing a license to a client device, the license providing a key for decrypting a content instance. In one embodiment, the method comprises accepting a token request, the token request having client device credentials including a client device identifier (client ID) and a content instance identifier (content ID), deriving a private key according to a token key seed, a token key identifier (token key ID), and the content ID, generating a token having a payload and a token identifier (token ID) and being digitally signed according to the derived private key; transmitting the generated token to the client; and providing the license to the client device according to the generated token. Another embodiment is evidenced by a processor having a communicatively coupled memory having processor instructions for performing the foregoing operations.

The foregoing discloses an apparatus, method and system for of providing a license to a client device. One embodiment is evidenced by a method comprising: accepting a token request, the token request having client device credentials including a client device identifier (client ID) and a content instance identifier (content ID); deriving a private key according to a token key seed, a token key identifier (token key ID), and the content ID; and generating a token, the token having a payload and a token identifier (token ID), the generated token having a digital signature generated according to the derived private key; transmitting the generated token to the client; and providing the license to the client device according to the generated token.

Implementations may include one or more of the following features:

Any of the methods described above, wherein: the token is generated and provided to the client by a first service, the license is provided by a second service, the token key seed is a secret shared by the first service and the second service, and the license is provided to the client only if the generated token is authenticated by the second service according to a rederived private key.

Any of the methods described above, wherein the token key identifier is randomly generated.

Any of the methods described above, wherein providing the license to the client according to the generated token includes: receiving a license request, the license request including the generated token, the token key ID and the content ID; rederiving the private key according to the token key seed, the received token key ID and the received content ID; authenticating the digital signature of the generated token according to the rederived private key; and providing the license to the client device according to the authentication of the generated token.

Any of the methods described above, wherein the generated token is an encrypted token, generated by: generating a random key; encrypting the generated token according to the random key; encrypting the random key according to the derived private key; and generating the encrypted token from the encrypted random key and the encrypted generated token. the method further includes: decrypting the encrypted random key according to the rederived private key; decrypting the encrypted generated token according to the random key; and providing the license to the client device according to the authentication of the generated token includes: providing the license to the client device according to the authentication of the decrypted generated token.

Any of the methods described above, wherein generating a token includes: generating an encrypted token by enciphering the payload and the token identifier (token ID) and generating the digital signature in a single-pass operation according to the private key; and the method further includes: decrypting the encrypted token according to the private key; and providing the license to the client device according to the authentication of the generated token includes: providing the license to the client device according to the authentication of the decrypted token.

Any of the methods described above, wherein the derived private key and the rederived private key are derived according to a key derivation function (KDF) having user-configurable input parameters mapped to the token key seed, token key ID, and the content ID. The method wherein the KDF is a hash message authentication code (HMAC) key derivation function, and wherein: a key secret input parameter is mapped to the token key seed; a salt input parameter is mapped to the token key ID; and a context input parameter is mapped to the content ID.

Another embodiment is evidenced by an apparatus for providing a license to a client device, the license providing a key for decrypting a content instance. The apparatus comprises: a processor; a memory, communicatively coupled to the processor, the memory storing processor instructions including processor instructions for: accepting a token request, the token request having client device credentials including a client device identifier (client ID) and a content instance identifier (content ID); deriving a private key according to a token key seed, a token key identifier (token key ID), and the content ID; and generating a token, the token having a payload and a token identifier (token ID), the generated token having a digital signature generated according to the derived private key; transmitting the generated token to the client; and providing the license to the client device according to the generated token.

Implementations may include one or more of the following features:

Any apparatus described above, wherein: the token is generated and provided to the client by a first service, the license is provided by a second service, the token key seed is a secret shared by the first service and the second service, and the license is provided to the client only if the generated token is authenticated by the second service according to a rederived private key. The apparatus wherein the token key identifier is randomly generated.

Any apparatus described above, wherein the processor instructions for providing the license to the client according to the generated token include processor instructions for: receiving a license request, the license request including the generated token, the token key ID and the content identifier; rederiving the private key according to the token key seed, the received token key ID and the received content ID; authenticating the digital signature of the generated token according to the rederived private key; and providing the license to the client device according to the authentication of the generated token.

Any apparatus described above, wherein the generated token is an encrypted token, generated by: generating a random key; encrypting the token according to the random key; encrypting the random key according to the derived private key; and generating the encrypted token from the encrypted random key and the encrypted token. the processor instructions further include processor instructions for: decrypting the encrypted random key according to the rederived private key; decrypting the generated token according to the random key; and the processor instructions for providing the license to the client device according to the authentication of the generated token include processor instructions for: providing the license to the client device according to the authentication of the decrypted generated token.

Any apparatus described above, wherein the processor instructions for generating a token include processor instructions for: generating an encrypted token by enciphering the payload and the token identifier (token ID) and generating the digital signature in a single-pass operation according to the private key; and the processor instructions further include processor instructions for: decrypting the encrypted token according to the private key; and the processor instructions for providing the license to the client device according to the authentication of the generated token include processor instructions for: providing the license to the client device according to the authentication of the decrypted token.

Any apparatus described above, wherein the derived private key and the rederived private key are derived according to a key derivation function (KDF) having user-configurable input parameters mapped to the token key seed, token key ID, and the content ID.

Any apparatus described above, wherein the KDF is a hash message authentication code (HMAC) key derivation function, and wherein: a key secret input parameter is mapped to the token key seed; a salt input parameter is mapped to the token key ID; and a context input parameter is mapped to the content ID.

### CONCLUSION

This concludes the description of the preferred embodiments of the present disclosure. The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A method of providing a license to a client device, the license providing a key for decrypting a content instance, comprising:
accepting a token request, the token request having client device credentials including a client device identifier (client ID) and a content instance identifier (content ID);
deriving a private key according to a token key seed, a token key identifier (token key ID), and the content ID; and
generating a token, the token having a payload and a token identifier (token ID), the generated token having a digital signature generated according to the derived private key;
transmitting the generated token to the client; and
providing the license to the client device according to the generated token.

2. The method of claim 1 wherein:
the token is generated and provided to the client by a first service;
the license is provided by a second service;
the token key seed is a secret shared by the first service and the second service; and
the license is provided to the client only if the generated token is authenticated by the second service according to a rederived private key.

3. The method of claim 2, wherein the token key identifier is randomly generated.

4. The method of claim 1, wherein providing the license to the client according to the generated token comprises:
receiving a license request, the license request comprising the generated token, the token key ID and the content ID;
rederiving the private key according to the token key seed, the received token key ID and the received content ID;
authenticating the digital signature of the generated token according to the rederived private key; and
providing the license to the client device according to the authentication of the generated token.

5. The method of claim 4, wherein:
the generated token is an encrypted token, generated by:
generating a random key;
encrypting the generated token according to the random key;
encrypting the random key according to the derived private key; and
generating the encrypted token from the encrypted random key and the encrypted generated token.
the method further comprises:
decrypting the encrypted random key according to the rederived private key;
decrypting the encrypted generated token according to the random key; and
providing the license to the client device according to the authentication of the generated token comprises:
providing the license to the client device according to the authentication of the decrypted generated token.

6. The method of claim 4, wherein:
generating a token comprises:
generating an encrypted token by enciphering the payload and the token identifier (token ID) and generating the digital signature in a single-pass operation according to the private key; and
the method further comprises:
decrypting the encrypted token according to the private key; and
providing the license to the client device according to the authentication of the generated token comprises:
providing the license to the client device according to the authentication of the decrypted token.

7. The method of claim 1, wherein the derived private key and the rederived private key are derived according to a key derivation function (KDF) having user-configurable input parameters mapped to the token key seed, token key ID, and the content ID.

8. The method of claim 7, wherein the KDF is a hash message authentication code (HMAC) key derivation function, and wherein:
a key secret input parameter is mapped to the token key seed;
a salt input parameter is mapped to the token key ID; and
a context input parameter is mapped to the content ID.

9. An apparatus for providing a license to a client device, the license providing a key for decrypting a content instance, comprising:
a processor;
a memory, communicatively coupled to the processor, the memory storing processor instructions comprising processor instructions for:
accepting a token request, the token request having client device credentials including a client device identifier (client ID) and a content instance identifier (content ID);
deriving a private key according to a token key seed, a token key identifier (token key ID), and the content ID; and
generating a token, the token having a payload and a token identifier (token ID), the generated token having a digital signature generated according to the derived private key;
transmitting the generated token to the client; and
providing the license to the client device according to the generated token.

10. The apparatus of claim 9 wherein:
the token is generated and provided to the client by a first service;
the license is provided by a second service;
the token key seed is a secret shared by the first service and the second service; and
the license is provided to the client only if the generated token is authenticated by the second service according to a rederived private key.

11. The apparatus of claim 10, wherein the token key identifier is randomly generated.

12. The apparatus of claim 9, wherein the processor instructions for providing the license to the client according to the generated token comprise processor instructions for:
receiving a license request, the license request comprising the generated token, the token key ID and the content identifier;
rederiving the private key according to the token key seed, the received token key ID and the received content ID;
authenticating the digital signature of the generated token according to the rederived private key; and
providing the license to the client device according to the authentication of the generated token.

13. The apparatus of claim 12, wherein:
the generated token is an encrypted token, generated by:
generating a random key;
encrypting the token according to the random key;
encrypting the random key according to the derived private key; and
generating the encrypted token from the encrypted random key and the encrypted token.
the processor instructions further comprise processor instructions for:
decrypting the encrypted random key according to the rederived private key;
decrypting the generated token according to the random key; and
the processor instructions for providing the license to the client device according to the authentication of the generated token comprise processor instructions for:
providing the license to the client device according to the authentication of the decrypted generated token.

14. The apparatus of claim 12, wherein:
the processor instructions for generating a token comprise processor instructions for:
generating an encrypted token by enciphering the payload and the token identifier (token ID) and generating the digital signature in a single-pass operation according to the private key; and
the processor instructions further comprise processor instructions for:
decrypting the encrypted token according to the private key; and
the processor instructions for providing the license to the client device according to the authentication of the generated token comprise processor instructions for:
providing the license to the client device according to the authentication of the decrypted token.

15. The apparatus of claim 9, wherein the derived private key and the rederived private key are derived according to a key derivation function (KDF) having user-configurable input parameters mapped to the token key seed, token key ID, and the content ID.

16. The apparatus of claim 15, wherein the KDF is a hash message authentication code (HMAC) key derivation function, and wherein:
a key secret input parameter is mapped to the token key seed;
a salt input parameter is mapped to the token key ID; and
a context input parameter is mapped to the content ID.

17. An apparatus of providing a license to a client device, the license providing a key for decrypting a content instance, comprising:
means for accepting a token request, the token request having client device credentials including a client device identifier (client ID) and a content instance identifier (content ID);
means for deriving a private key according to a token key seed, a token key identifier (token key ID), and the content ID; and
means for generating a token, the token having a payload and a token identifier (token ID), the generated token having a digital signature generated according to the derived private key;
means for transmitting the generated token to the client; and
means for providing the license to the client device according to the generated token.

18. The apparatus of claim 17 wherein:
the token is generated and provided to the client by a first service;
the license is provided by a second service;
the token key seed is a secret shared by the first service and the second service; and
the license is provided to the client only if the generated token is authenticated by the second service according to a rederived private key.

19. The apparatus of claim 18, wherein the token key identifier is randomly generated.

20. The apparatus of claim 17, wherein means for providing the license to the client according to the generated token comprises:
means for receiving a license request, the license request comprising the generated token, the token key ID and the content identifier;
means for rederiving the private key according to the token key seed, the received token key ID and the received content ID;
means for authenticating the digital signature of the generated token according to the rederived private key; and
means for providing the license to the client device according to the authentication of the generated token.
